(19) United States
(12) Patent Application Publication
(10) Pub. No.: US 2026/0027744 A1
(43) Pub. Date: Jan. 29, 2026

(54) METHOD FOR DIAGNOSING A MALFUNCTION IN A SLICING MACHINE AND SLICING MACHINE

(71) Applicant: MULTIVAC SEPP HAGGENMÜLLER SE & CO. KG, Wolfertschwenden (DE)

(72) Inventors: Julian RIEBLINGER, Wolfertschwenden (DE); Tom STACHEL, Wolfertschwenden (DE); Albert HARTMANN, Wolfertschwenden (DE); Markus WÄGELE, Wolfertschwenden (DE); Mario GERBER, Wolfertschwenden (DE)

(73) Assignee: MULTIVAC SEPP HAGGENMÜLLER SE & CO. KG, Wolfertschwenden (DE)

(21) Appl. No.: 19/280,763

(22) Filed: Jul. 25, 2025

(30) Foreign Application Priority Data
Jul. 26, 2024 (DE) 102024121303.5

(51) Int. Cl. B26D 5/00; B26D 7/22

(52) U.S. Cl. CPC B26D 5/00; B26D 7/225

(57) ABSTRACT

A method for diagnosing an operational malfunction in a slicing machine comprises: displaying, using a display device of a user interface of the slicing machine, an operational malfunction area selection view, which includes multiple possible operational malfunction areas for the malfunction and a prompt to select at least one operational malfunction area, selecting, using an input device of the user interface, the at least one operational malfunction area, displaying, using the display device, an operational malfunction type selection view, which includes multiple possible operational malfunction types for the malfunction and a prompt to select at least one operational malfunction type from the multiple possible operational malfunction types, and selecting, using the input device, the at least one operational malfunction type, and displaying, using the display device, at least one operational malfunction resolution suggestion based on the at least one operational malfunction area and/or the at least one operational malfunction type.

### CROSS-REFERENCE TO RELATED APPLICATIONS

This application claims foreign priority benefits under 35 U.S.C. § 119 (a)-(d) to German patent application number DE 102024121303.5, filed Jul. 26, 2024, which is incorporated by reference in its entirety.

### TECHNICAL FIELD

The disclosure relates to a method for diagnosing an operational malfunction in a slicing machine. The disclosure further relates to a slicing machine.

### SUMMARY

It should be noted at this point that the method and/or the slicing machine can be designed according to the disclosure to slice food, for example in the form of products or so-called product calibres (e.g., elongated products), into slices from which, preferably as shingled, stacked or folded slices, portions can be formed. The products or product calibres can, for example, consist of sausage, cheese, cultivated meat, pressed meat and similar.

If a malfunction occurs in the slicing machine during a slicing operation, which affects the slicing results of the machine, such as the quality of the sliced pieces or the portions formed, this malfunction can often be rectified by specifically adjusting one or more operational parameters. Since known slicing machines or slicing methods generally have a multitude of operational parameters, it can be comparatively time-consuming for an operator of the slicing machine to remedy a particular operational malfunction, especially if a multitude of troubleshooting attempts are required to resolve the operational malfunction. Additionally, the ability of a particular operator to rectify a malfunction often depends heavily on individual experience, leading to insufficient flexibility if a slicing machine is to be operated by different operators.

Additionally, the rectification of operational malfunctions is often associated with long downtime of the slicing machine, which can lead to a reduction in the throughput of the slicing machine and thus to significant economic loss.

Therefore, it is an object of the disclosure to provide a remedy here. In particular, it is an object of the disclosure to provide a method with which an operational malfunction of a slicing machine can be resolved in a comparatively time-efficient manner and independently of the experience of the respective operator of the slicing machine. Furthermore, it is an object of the disclosure to provide a corresponding slicing machine.

This object is solved by a method according to the disclosure for diagnosing an operational malfunction in a slicing machine, wherein the method comprises the following steps:

Display, using a display device of a user interface of the slicing machine, a malfunction area selection view, which includes a plurality of possible malfunction areas for the malfunction and a prompt to select at least one malfunction area from the plurality of possible malfunction areas.

Select, using an input device of the user interface, the at least one operational malfunction area,

Display, through the display device, an operational malfunction type selection view, which includes a plurality of possible operational malfunction types for the malfunction and a prompt to select at least one operational malfunction type from the plurality of possible operational malfunction types, selecting, through the input device, the at least one operational malfunction type, and

Display, by means of the display device, at least one operational troubleshooting suggestion based on the selected at least one operational malfunction area and/or the selected at least one type of operational malfunction.

According to the disclosure, a diagnosis of an operational malfunction of the slicing machine can therefore be made by displaying the operational malfunction area selection view, selecting at least one operational malfunction area, displaying the type of operational malfunction selection view, and selecting at least one type of operational malfunction. This allows the operational malfunction to be precisely localized both in terms of its occurrence on the slicing machine and in terms of its nature. Based on the selected at least one operational malfunction area and/or the selected at least one type of operational malfunction, at least one suggestion is further displayed for rectifying the malfunction, so that a user/operator can diagnose or classify and rectify the operational malfunction essentially independently of their individual experience.

Each of the plurality of operational malfunction areas can be any local area, which for example relates to a predetermined location or a predetermined functional unit on the slicing machine, and/or which relates to a product to be sliced, especially in a predetermined processing state, for example as product calibre, as one or more slices, or as one or more portions.

The plural of operational malfunction areas, the plural of types of operational malfunctions, and/or at least one operational malfunction remediation suggestion can be stored in a storage unit of the slicing machine.

Furthermore, the operational malfunction area selection view and/or the type of operational malfunction selection view can each include one or more graphical representations, for example of components of the slicing machine, and/or one or more text-like representations, for example in the form of predetermined texts or text modules, to facilitate understanding and operation for an operator.

The user interface, comprising the input device and the display device, can for example be designed as a touch screen or similar. Furthermore, the user interface can be mounted on a frame or a rack of the slicing machine.

In principle, the content of the operational malfunction type selection view can be defined and/or displayed independently of the content of the operational malfunction area selection view, and vice versa. In order to further narrow down a possible type of operational malfunction depending on the area of the malfunction, it is proposed in one embodiment that the majority of possible types of operational malfunctions in the operational malfunction type selection view be defined depending on the selected at least one area of malfunction.

The majority of potential operational malfunction areas can fundamentally affect any local and/or functional areas of the slicing machine. However, it is preferably provided that the majority of possible operational malfunction areas include an area of a loading unit and/or an area of a feeding unit and/or an area of a slicing unit and/or an area of a portioning unit of the slicing machine. The loading unit can essentially be arranged upstream of the feed unit in the feed direction. Furthermore, the loading unit can be set up to automatically or manually load the slicing machine, in particular the feed unit, with products or product calibres to be sliced.

In principle, the method according to the disclosure can be applied to any type of slicing machine. When the method is applied in a multi-track slicing machine, in which a plurality of products or product calibres are preferably sliced substantially simultaneously and/or substantially parallel to each other on multiple tracks, it is preferred that the multiple possible operational malfunction areas include an area of a predetermined track and/or a number of predetermined tracks and/or all tracks, particularly of a portioning unit of the slicing machine.

In order to narrow down the type of operational malfunction as precisely as possible, the majority of possible types of operational malfunctions may include a malfunction related to one or more slices, which have been sliced using the slicing machine, and/or a malfunction related to one or more portions, which have been formed using the slicing machine. A portion can include one or several slices.

In the further development of the aforementioned embodiment, it is proposed that the operational malfunction related to one or more slices includes a malfunctioning slice parameter, particularly a malfunctioning slice thickness and/or a malfunctioning slice cross-section and/or a malfunctioning slice contour and/or a malfunctioning slice surface. This enables the type of operational malfunction to be pinpointed more precisely, thus allowing for an even better suited proposal for resolving the malfunction. In principle, other slice parameters not explicitly mentioned here, but familiar to those skilled in the art, can also be considered.

In the further development of the two aforementioned implementation examples, it is also proposed that the operational malfunction relating to one portion or multiple portions includes a malfunctioning portion parameter, especially a malfunctioning number of slices of a respective portion and/or a malfunctioning arrangement of a respective portion on a portioning unit of the slicing machine and/or a malfunctioning arrangement of slices of a respective portion relative to each other and/or a malfunctioning arrangement of multiple portions relative to each other on a portioning unit of the slicing machine. The incorrect arrangement of a respective portion on the portioning unit can, for example, include a displacement of the respective portion substantially transverse and/or parallel to a conveying direction of the respective portion. The incorrect arrangement of slices of a respective portion relative to each other can, for example, in the case of shingled portions include an uneven spacing of the shingled slices, i.e., arranged with partial overlap, relative to each other and/or, for example, in the case of stacked portions, a lack of

Concentricity of the slices of a respective portion. In principle, other portion parameters not explicitly mentioned here, but known to those skilled in the art, can also be considered.

If a cause of the operational malfunction is expected or actually affects an operational parameter of the slicing machine, according to a preferred embodiment, the at least one suggestion for resolving the operational malfunction may include adjusting at least one slicing operation parameter of the slicing machine.

In further development of this embodiment, the slicing operation parameter can include a slicing speed, particularly a rotational speed, of a slicing unit of the slicing machine and/or a slice thickness of a respective slice and/or a maintenance condition of a knife of the slicing unit. The maintenance condition of the knife can include a sharpness level of the knife or a number of operating hours and/or cuts of the knife that have occurred or been made since the knife was last sharpened. If the maintenance status, for example by the operator or a control unit of the slicing machine, is deemed to be not in order, it may be suggested using the display device to replace and/or maintain the knife, for example, to sharpen it.

Similarly, the cause can also be rooted in a product to be sliced, which is why, according to another embodiment, the at least one operational malfunction rectification suggestion includes adjusting at least one product parameter of a product or product calibre to be sliced by the slicing machine.

According to an enhancement of the aforementioned embodiment, it is suggested that the product parameter includes a temperature, especially a core temperature and/or a surface temperature, of the product or product calibre. In particular, the temperature can have a special influence on the achievable slicing result, where too high a temperature can lead to sticking or adhesion of the product or product calibre to a slicing unit, especially to a knife of a slicing unit of the slicing machine, while too low a temperature can lead to breaking of the product or product calibre during the slicing method and also to excessively severe wear of the knife.

To prevent malfunctioning slices and/or portions from being sliced during the analysis of the operational malfunction, according to an embodiment, the slicing operation of the slicing machine can be interrupted before displaying the operational malfunction area selection view and/or the type of operational malfunction selection view.

Should a case arise in which the operational malfunction cannot be resolved by the at least one suggested remedy for operational malfunctions, it is further proposed that, if the suggested remedy for operational malfunctions does not lead to the resolution of the operational malfunction, a service request command be entered into the input device, by means of which a service request signal is sent from the user interface to a communication unit not belonging to the slicing machine. For this purpose, a service button, or preferably in the case of a touchscreen, a service request control panel can be provided on the input device, whose activation can lead to contacting a service provider, such as the manufacturer of the slicing machine. The communication unit can be a signal receiving unit at the service provider, for example a server or a unit associated with it.

According to another aspect, the above object is solved by a slicing machine comprising a user interface with a display device and an input device, wherein the slicing machine is configured to perform the method described above, according to the disclosure.

According to one embodiment, the slicing machine may further comprise: preferably a loading unit, which is configured to load at least one product or product calibre into the slicing machine, a feed unit, which is configured to feed at least one product or product calibre along a feed direction, a slicing unit, which is configured to slice the at least one product or product calibre into slices, and a portioning unit, which is configured to form portions from the slices cut by the slicing unit, where each portion may comprise one or more slices. The feed unit can, for example, be designed as a continuously circulating belt conveyor or similar. Preferably, the slicing unit is arranged downstream of the feed unit in relation to the feed direction. The slicing unit may include a knife which, for example, can be driven to rotate about an axis of rotation by means of an electric drive unit. Using the knife, the slices can be separated from an end of each product or product calibre facing the slicing unit.

It should also be noted that the slicing machine may additionally include a gripping unit with at least one gripper, where the at least one gripper can be configured to grasp the at least one product or product calibre at its end facing away from the slicing unit.

Furthermore, the slicing machine can include a discharge unit that is configured to convey the portions sliced by the slicing unit along a discharge direction, particularly to an insertion unit, which can be configured to feed the portions to a further processing device, especially a packaging machine.

As already mentioned above, the slicing machine can ultimately be designed as a single-lane or multi-lane slicing machine.

### BRIEF DESCRIPTION OF THE DRAWINGS

The disclosure will be explained in more detail below with reference to the accompanying drawings of exemplary embodiments. Figures:

FIG. 1: a schematic and simplified side view of a slicing machine according to an embodiment of the disclosure;

FIG. 2: a schematic block diagram of the slicing machine according to the disclosure as per FIG. 1 with a user interface arranged thereon according to an embodiment; and

FIG. 3: a schematic top view of the slicing machine according to FIG. 1 or FIG. 2, which is designed as a multi-track slicing machine.

### DETAILED DESCRIPTION

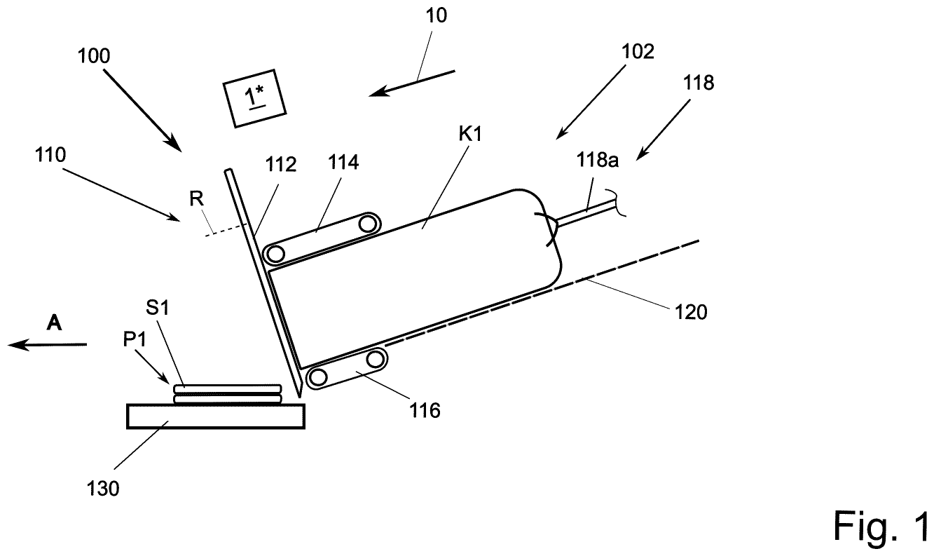

In FIG. 1, a slicing machine according to the disclosure, for example in the form of a slicer, is generally indicated by the reference numeral 100 according to an embodiment.

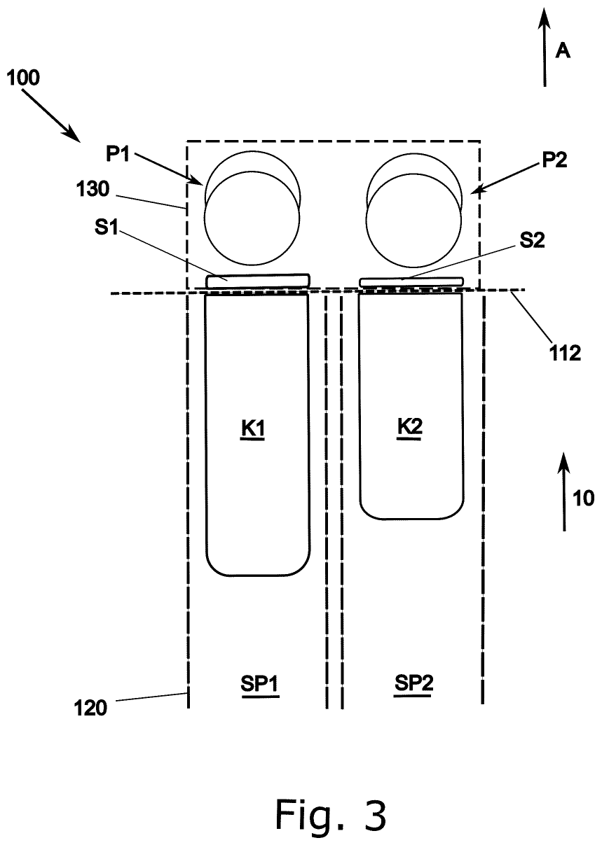

The slicing machine 100 can generally be designed as a single-lane or multi-lane slicing machine, but in the illustrated embodiment, it is implemented as a two-lane slicing machine (see FIG. 3). The slicing machine 100 includes a feeding unit 102, which is designed to feed products or product calibres K1 and K2 along a feed direction 10 to a slicing unit 110, where in FIG. 1 only the product calibre K1 is visible.

It should be noted that the present disclosure is by no means limited to slicing machines for slicing product calibres as illustrated in FIG. 1, but is generally applicable to slicing machines. Thus, the slicing machine could also be set up, for example, to slice products in the form of cultivated meat or similar with a varying cross-section in the feed direction, and/or include a pressing device (not shown) to press the products to a predetermined cross-section before slicing by the slicing unit.

The slicing unit 110 can include a knife 112 which, for example by means of an electric drive unit (not shown), can be driven to rotate about a rotational axis R. The knife 112, for example, can be designed as a sickle knife, which preferably has a radius that varies around the rotation axis R, especially increasing in the direction of rotation around the rotation axis R. Consequently, the knife 112 can initially open a slicing gap by partially rotating around the rotation axis R, allowing the product calibre K1 or K2 to advance in the feed direction 10, and upon further rotation around the rotation axis R, it can separate a slice S1 or S2 from the product calibre K1 or K2, which can then fall onto a portioning unit 130 to form stacked portions P1 or P2. With the portioning unit 130, and if desired, another downstream conveying unit (not shown) in the conveying direction A following the portioning unit 130, the slices S1 or portions P1 and/or the slices S2 or portions P2 can be transported in the conveying direction A, for example to a packaging machine (not shown) or similar.

At a front end thereof, the product calibres K1 and K2 can be guided by an upper traction belt 114 and/or a lower traction belt 116. The upper traction belt 114 and/or the lower traction belt 116 can be driven separately. However, it is generally sufficient if at least one of the upper traction belt 114 and the lower traction belt 116 can be driven in a circulating manner in and preferably against the feed direction 10. Moreover, the slicing machine 100 may include a gripper unit 118 with at least one gripper 118a, which can be configured to grip the product calibre K1 at an end facing away from the slicing unit 110. For the product calibre K2, the gripping unit 118 can include an additional gripper corresponding to gripper 118a, which, however, is not shown in the figures.

Before and during slicing, the product calibres K1 and K2 can rest on a feed conveyor 120, which may be designed as a belt conveyor and is also only schematically represented in FIG. 1.

Furthermore, FIG. 1 schematically indicates a control unit 1* of the slicing machine 100, by means of which the slicing unit 110 and the feed unit 102 of the slicing machine 100, as well as preferably all other movable parts of the slicing machine 100, can be controlled. The upper traction belt 114, the lower traction belt 116, the feed conveyor 120, and the gripping unit 118 can be associated with the feed unit 102.

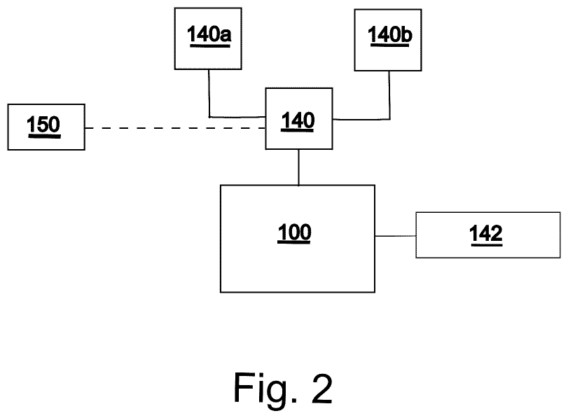

In FIG. 2, a schematic block diagram of the slicing machine 100 according to FIG. 1 with a user interface 140 according to the disclosure arranged thereon is schematically shown. The user interface 140 is not shown in FIG. 1 merely for reasons of clarity. The user interface 140 includes a display device 140a, which can be in the form of a display and/or a touchscreen, for example. Additionally, the user interface 140 includes an input device 140b, which can be designed as one or more buttons or also as a touchscreen. If the display device 140 includes the touchscreen, the display device 140a and the input device 140b can be formed as a single unit, as the touchscreen is known to enable both a graphical display and, for example, manual input by a user/operator.

The slicing machine 100, including the user interface 140 arranged thereon, can consequently be configured to carry out the method according to the disclosure for diagnosing an operational malfunction in the slicing machine 100.

In the event of an operational malfunction, an operational malfunction area selection view can first be displayed using the display device 140a, which includes a plurality of possible operational malfunction areas for the malfunction as well as a prompt to select at least one operational malfunction area. The majority of possible operational malfunction areas may include an area of the loading unit (not shown), an area of the feeding unit 102 or a part thereof, and/or an area of the slicing unit 110 and/or an area of the portioning unit 130 of the slicing machine 100. If the slicing machine 100, as shown in the depicted embodiment, is designed as a multi-track slicing machine, the majority of potential operational malfunction areas can also include an area of one or more predetermined tracks SP1, SP2 (see FIG. 3) and/or all tracks SP1 and SP2, especially the portioning unit 130 of the slicing machine 100, so that a user/operator can already determine whether a potential operational malfunction occurs only on one track or on multiple or all tracks of the slicing machine 100.

The areas of operational malfunction can, for example, be displayed using graphical representations on the display device 140a, so that a user of the slicing machine 100 can select one or more areas of operational malfunction that are displayed on the display device 140a.

Preferably after a user/operator has selected the at least one operational malfunction area, a preferably graphical operational malfunction type selection view is displayed using the display device 140a, which includes a plurality of possible types of operational malfunctions for the malfunction and a prompt to select at least one type of operational malfunction.

The majority of possible types of operational malfunctions can involve a malfunction related to one or more slices S1 and/or S2, which have been sliced using the slicing machine 100. Additionally or alternatively, the majority of possible types of operational malfunctions may include an operational malfunction relating to one or more portions P1 and/or P2, which have been formed by the slicing machine 100, specifically by the portioning unit 130. If this involves an operational malfunction related to one or more slices S1 and/or S2, it can, for example, include a malfunctioning slice parameter, such as a malfunctioning slice thickness of a slice S1 and/or S2. If the operational malfunction is a malfunction related to one or more portions P1 and/or P2, then the operational malfunction may involve a malfunctioning portion parameter, such as a malfunctioning number of slices in a respective portion P1 and/or P2, and/or a malfunctioning arrangement of a respective portion P1 and/or P2 on the portioning unit 130, and/or a malfunctioning arrangement of slices S1 and/or S2 of a respective portion P1 or P2 relative to each other, and/or a malfunctioning arrangement of several portions P1 and/or P2 relative to each other.

As soon as a user/operator has selected at least one operational malfunction area and at least one type of operational malfunction, the method according to the disclosure uses the display device 140a to display at least one suggestion for resolving the operational malfunction based on the selected operational malfunction area and/or the type of operational malfunction. The proposal for troubleshooting can also be presented in the form of a graphic representation, which can include both pictorial and text-like components. For instance, it is conceivable that a graphical representation of a functional unit, such as the slicing unit 110, of the slicing machine 100 is displayed, along with a prompt in the form of a text being issued, where a user/operator is requested to adjust, for example, a slicing operation parameter of the slicing machine 100. A slicing operation parameter can, for example, include a slicing speed, particularly a rotational speed, of the slicing unit 110, i.e., the knife 112, around the rotational axis R, and/or a slice thickness of a respective slice S1 and/or S2, and/or a maintenance condition of the knife 112. The troubleshooting proposal can therefore include a request in which the user/operator is asked to adjust at least one slicing operation parameter of the slicing machine 100, while text modules such as “increase speed” and/or “reduce speed” and/or “increase slice thickness” and/or “reduce slice thickness” and/or “check knife and change if necessary” can be displayed.

If necessary, in addition or alternatively, the operational malfunction resolution proposal may include adjusting at least one product parameter of the product calibre K1 and/or K2, where the product parameter may include a temperature, such as a core temperature and/or a surface temperature, of the product calibre K1 and/or K2. Accordingly, the display device 140a can also display text modules that include prompts such as “Check product temperature” and/or “Product temperature too low/too high”.

If the operational malfunction resolution proposal does not resolve the operational malfunctions, a service request command can also be entered into the input device 140b, by means of which a service request signal can be sent to a communication unit 150 that does not belong to the slicing machine and may be located, for example, at a service site and/or enable communication with a service provider for the slicing machine 100.

It should also be mentioned that the slicing machine 100 can additionally include a storage unit 142, for example in the form of a permanent memory or an external memory, particularly in the form of a cloud or similar, or can be connected therewith. The storage unit 142 can store the plurality of types of operational malfunctions and/or the plurality of operational malfunction areas and/or the at least one operational malfunction remediation suggestion. Based on the data stored in the control unit 142, the control unit 1* of the slicing machine 100 can consequently carry out the method according to the disclosure using suitable software and, based on the inputs from the user/operator into the input device 140b of the user interface 140, determine a corresponding troubleshooting suggestion and output it using the display device 140b.

FIG. 3 finally shows a schematic top view of the slicing machine 100 according to FIG. 1 or FIG. 2, which is designed as a multi-track slicing machine and has tracks SP1 and SP2. These tracks are preferably separately drivable in the feeding direction 10 in the area of the feeder 120 and/or separately drivable in the discharge direction A in the area of the portioning unit 130. In FIG. 3, the knife 112, the feeder 120, and the portioning unit 130 are merely indicated schematically by dashed lines. The gripping unit 118 and the user interface 140 are not shown in FIG. 3 for reasons of clarity. Accordingly, the slicing machine 100 can slice product calibres K1 and K2 on tracks SP1 and SP2 essentially simultaneously, forming slices S1 and S2 or portions P1 and P2, respectively. The portions P1 and P2 are exemplarily shown as shingled portions, deviating from FIG. 1, in which the slices S1 and S2 of a respective portion P1 or P2 are arranged only partially overlapping.

As one skilled in the art would understand, the control unit 1*, as well as any other control, controller, device, interface, unit, system, subsystem, sensor, or the like described herein may individually, collectively, or in any combination comprise appropriate circuitry, such as one or more appropriately programmed processors (e.g., one or more microprocessors including central processing units (CPU)) and associated memory, which may include stored operating system software, firmware, and/or application software executable by the processor(s) for controlling operation thereof and for performing the particular algorithm or algorithms represented by the various methods, functions and/or operations described herein, including interaction between and/or cooperation with each other. One or more of such processors, as well as other circuitry and/or hardware, may be included in a single Application-Specific Integrated Circuitry (ASIC), or several processors and various circuitry and/or hardware may be distributed among several separate components, whether individually packaged or assembled into a System-on-a-Chip (SoC).

What is claimed is:

1. A method for diagnosing an operational malfunction in a slicing machine, wherein the method comprises:
displaying, using a display device of a user interface of the slicing machine, an operational malfunction area selection view, which includes a plurality of possible operational malfunction areas for the operational malfunction and a prompt to select at least one operational malfunction area from the plurality of possible operational malfunction areas;
receiving a selection of the at least one operational malfunction area via an input device of the user interface;
displaying, using the display device, an operational malfunction type selection view, which includes a plurality of possible operational malfunction types for the malfunction and a prompt to select at least one operational malfunction type from the plurality of possible operational malfunction types;
receiving a selection of the at least one operational malfunction type via the input device; and
displaying, using the display device, at least one operational malfunction remedy suggestion based on the selected at least one operational malfunction area and/or the selected at least one operational malfunction type.

2. The method according to claim 1, wherein a majority of possible types of operational malfunctions in the operational malfunction type selection view are defined depending on the selected at least one operational malfunction area.

3. The method according to claim 1, wherein a majority of possible operational malfunction areas include an area of a loading unit and/or an area of a feeding unit and/or an area of a slicing unit and/or an area of a portioning unit of the slicing machine.

4. The method according to claim 1, wherein a majority of possible operational malfunction areas include an area of a predetermined track and/or a plurality of predetermined tracks and/or all tracks of the slicing machine (100).

5. The method according to claim 1, wherein a majority of possible types of operational malfunctions comprises
a malfunction related to a slice or several slices, which have been sliced using the slicing machine, and/or
a malfunction related to one portion or several portions, which has/have been formed by the slicing machine.

6. The method according to claim 5, wherein the operational malfunction in relation to one slice or the several slices includes a malfunctioning slice parameter.

7. The method according to claim 6, wherein the malfunction slice parameter comprises a malfunctioning slice thickness and/or a malfunctioning slice cross-section and/or a malfunctioning slice contour and/or a malfunctioning slice surface.

8. The method according to claim 5, wherein the operational malfunction relates to one portion or several portions involving a malfunctioning portion parameter.

9. The method according to claim 8, wherein the malfunctioning portion parameter comprises a malfunctioning number of slices of a respective portion and/or a malfunctioning arrangement of a respective portion on a portioning unit of the slicing machine and/or a malfunctioning arrangement of slices of a respective portion relative to each other and/or a malfunctioning arrangement of several portions relative to each other on the portioning unit of the slicing machine.

10. The method according to claim 1, wherein the at least one operational malfunction remedy suggestion includes adjusting at least one slicing operation parameter of the slicing machine.

11. The method according to claim 10, wherein the at least one slicing operation parameter includes a slicing speed of a slicing unit of the slicing machine and/or a slice thickness of a respective slice and/or a maintenance condition of a knife of the slicing unit.

12. The method according to claim 1, wherein the at least one operational malfunction remedy suggestion includes adjusting at least one product parameter of a product or product calibre to be sliced by the slicing machine.

13. The method according to claim 12, wherein the at least one product parameter includes a temperature of the product or product calibre.

14. The method according to claim 13, wherein the temperature comprises a core temperature and/or a surface temperature of the product or product calibre.

15. The method according to claim 1, wherein before displaying the operational malfunction area selection view and/or the operational malfunction type selection view, a slicing operation of the slicing machine is interrupted.

16. The method according to claim 1, wherein, if the at least one operational malfunction remedy suggestion does not lead to rectification of the operational malfunction, the method further comprises enabling a service request command to be entered into the input device, so that a service request signal is sent from the user interface to a communication unit that is not part of the slicing machine.

17. A slicing machine comprising a user interface with a display device and an input device, wherein the slicing machine is configured to perform the method according to claim 1.

18. The slicing machine according to claim 17, further comprising:
a feed unit configured to feed at least one product or product calibre along a feed direction;
a slicing unit configured to slice the at least one product or product calibre into slices; and
a portioning unit configured to form portions from the slices cut by the slicing unit, wherein each portion includes one or more slices.

19. A slicing machine comprising:
a user interface including a display device and an input device, wherein the display device is configured to display an operational malfunction area selection view, which includes a plurality of possible operational malfunction areas for an operational malfunction in the slicing machine and a prompt to select at least one operational malfunction area from the plurality of possible operational malfunction areas, the input device is configured to enable a user to select the at least one operational malfunction area, the display device is configured to display an operational malfunction type selection view, which includes a plurality of possible operational malfunction types for the operational malfunction and a prompt to select at least one operational malfunction type from the plurality of possible operational malfunction types, the input device is configured to then enable the user to select the at least one operational malfunction type, and the display device is configured to then display at least one operational malfunction remedy suggestion based on the selected at least one operational malfunction area and/or the selected at least one operational malfunction type.
